(19) United States
(12) Patent Application Publication
(10) Pub. No.: US 2014/0340352 A1
(43) Pub. Date: Nov. 20, 2014

(54) INPUTTING DEVICE

(71) Applicant: ALPS Electric Co., Ltd., Tokyo (JP)

(72) Inventors: Satoshi NAKAJIMA, Miyagi-ken (JP); Satoshi HAYASAKA, Miyagi-ken (JP)

(73) Assignee: ALPS ELECTRIC CO., LTD., Tokyo (JP)

(21) Appl. No.: 14/249,753

(22) Filed: Apr. 10, 2014

(30) Foreign Application Priority Data
May 15, 2013 (JP) 2013-102749

(51) Int. Cl. G06F 3/044

(52) U.S. Cl. CPC G06F 3/044
USPC 345/174

(57) ABSTRACT

AN inputting device includes: a coordinate inputting unit in which multiple capacitance detection units are arranged, and at which an operating body performs a close proximity operation; a capacitance measurement unit that measures an electrostatic capacitance of each capacitance detection unit and outputs the measured electrostatic capacitance as a measurement signal; and a control unit that controls the capacitance measurement unit, associates the measurement signal with coordinate information on the capacitance detecting unit, obtains and calculates the associated measurement signal, calculates, and, outputs a control signal, in which the control unit determines attention coordinates, compares a value of the measurement signal of the determined attention coordinates and each value of the measurement signals of the multiple pieces of coordinate information adjacent to the attention coordinates, and, detects the attention coordinates as an operating point at which an operating body performs the close proximity operation.

### CLAIM OF PRIORITY

This application claims benefit of priority to Japanese Patent Application No. 2013-102749 filed on May 15, 2013, which is hereby incorporated by reference in its entirety.

### BACKGROUND

1. Field of the Disclosure

The present disclosure relates to a coordinate inputting device and particularly to a coordinate inputting device that quickly responds to an inputting operation.

2. Description of the Related Art

In the related art, there is an electrostatic capacitance-type coordinate inputting device in which an operating position is determined by detecting a change in electrostatic capacitance that results from an operation by an operator's finger.

An operator's inputting operation is different from an inputting operation in a switch, a rotary encoder, or the like. In a coordinate inputting device, an operator's may use an intuitive inputting operation. Thus, the coordinate inputting device has a wide range of application to various devices and also an ever-diversifying usage environment.

A coordinate detection device (an inputting device) illustrated in FIG. 8 is disclosed in Japanese Unexamined Patent Application Publication No. 2013-3977. The coordinate detection device 900 in Japanese Unexamined Patent Application Publication No. 2013-3977 is configured such that detection units 914 and 915 detect electrostatic capacitances of multiple electrodes 912 and 913 that are arranged along the X-direction and the Y-direction, that orthogonally intersects the X-direction, respectively. A storage unit 917 stores the detected electrostatic capacitances, and an arithmetic operation processing unit 918 performs arithmetic operation processing, based on the stored electrostatic capacitances.

The detection unit 914 detects the electrostatic capacitances of the multiple electrodes 912 in the order that they are arranged in the direction from one end of a line of the multiple electrodes 912 to the other end. The detection unit 915 detects the electrostatic capacitances of the multiple electrodes 913 in the order that they are arranged in the direction from one end of a line of the multiple electrodes 913 to the other end. The arithmetic operation processing unit 918 determines a detection-target coordinate region, based on a value that results from comparing amounts of change in the electrostatic capacitances of the adjacent electrodes and on the magnitude of the amount of change in the electrostatic capacitance of the detected electrodes.

However, in the inputting device described above, based on the electrostatic capacitance stored in each of the multiple electrodes, the value (a difference) that results from comparing the amount of change in the electrostatic capacitances of the electrodes that are adjacent to one another in a predetermined direction is calculated and thus an inclination is obtained. Then, an inclination that is greater than a predetermined value is calculated. Because the number of times that an arithmetic operation is performed in the arithmetic operation processing unit is increased and it takes time to perform the arithmetic operation, there is a problem in that a concern occurs that the inputting device will respond slowly to the inputting operation.

### SUMMARY

According to an aspect of the present invention, there is provided an inputting device including: a coordinate inputting unit in which multiple capacitance detection units are arranged in a matrix, and at which an operating body performs a close proximity operation; a capacitance measurement unit that measures an electrostatic capacitance of each of the multiple capacitance detection units and outputs the measured electrostatic capacitance as a measurement signal; and a control unit that controls the capacitance measurement unit, associates the measurement signal with coordinate information on the capacitance detection unit, obtains and calculates the associated measurement signal, calculates, and based on a result of the calculation, outputs a control signal. The control unit determines attention coordinates in an order according to the coordinate information on the capacitance detection units, compares a value of the measurement signal of the determined attention coordinates and each of the values of the measurement signals of the multiple pieces of coordinate information that are adjacent to the attention coordinates. If the value of the measurement signal of the attention coordinates is equal to or greater than the values of the measurement signals of the multiple pieces of coordinate information that are adjacent to the attention coordinates, detects the attention coordinates as an operating point at which an operating body performs a close proximity operation.

Accordingly, the operating point at which the operating body performs the close proximity operation can be detected by repeating the comparison of the value of the measurement signal of the attention coordinates and the values of the measurement signals of the multiple pieces of coordinate information that are adjacent to the attention coordinates. For this reason, because the number of times that the arithmetic operation is performed is decreased without performing the complex arithmetic operation, the processing can be quickly performed on the inputting operation. Therefore, the number of times that the arithmetic operation is performed is small, and the inputting device that quickly responds to the inputting operation can be provided.

### BRIEF DESCRIPTION OF THE DRAWINGS

FIG. 1 is a block diagram illustrating a configuration of an inputting device according to an embodiment of the present invention;

FIG. 2 is a schematic diagram of an external appearance of the inputting device according to the embodiment of the present invention;

FIG. 3 is a flow chart illustrating an outline of operation of the inputting device according to the embodiment of the present invention;

FIG. 4 is a flow chart illustrating detailed processing steps that result from subdivision of Step S1 in FIG. 3;

FIG. 5 is a flow chart illustrating detailed processing steps that result from subdivision of Step S2 in FIG. 3;

FIG. 6 is a flow chart illustrating detailed processing steps that result from subdivision of Step S3 in FIG. 3;

FIGS. 7A to 7C are diagrams, each illustrating an example of results of operations in the flow charts illustrated in FIGS. 4 and 5; and

FIG. 8 is a diagram illustrating a configuration of an inputting device in an example 1 in the related art.

### DESCRIPTION OF THE EXEMPLARY EMBODIMENTS

### First Embodiment

An inputting device 100 according to a first embodiment of the present invention is described below.

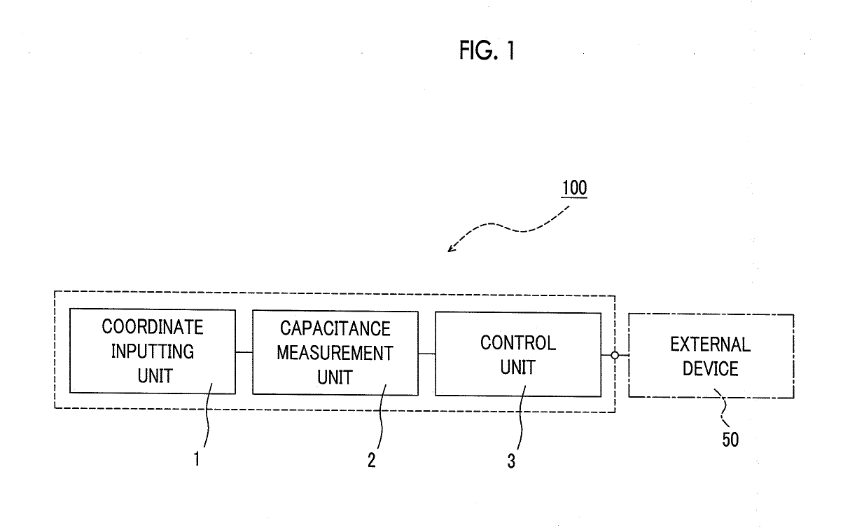

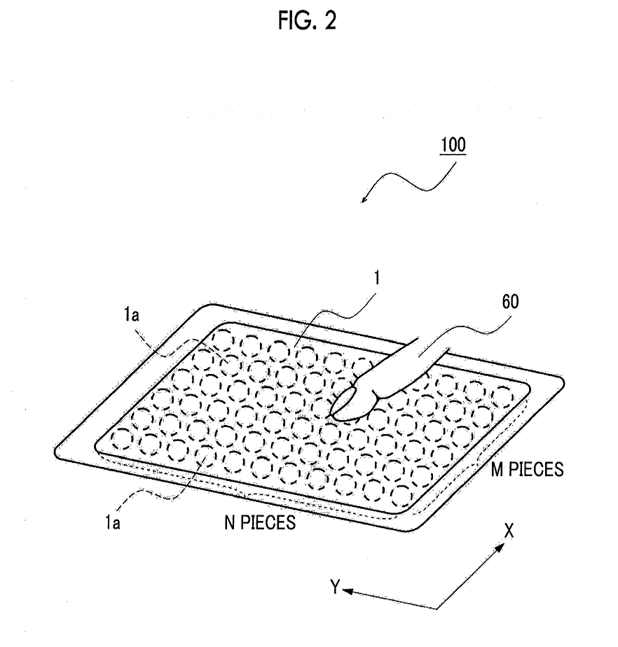

First of all, a configuration of the inputting device 100 according to the embodiment of the present invention is described referring to FIGS. 1 and 2. FIG. 1 is a block diagram illustrating the configuration of the inputting device 100. FIG. 2 is a schematic diagram of an external appearance of the inputting device 100.

The inputting device 100, as illustrated in FIG. 1, includes a coordinate inputting unit 1, a capacitance measurement unit 2, and a control unit 3. The coordinate inputting unit 1 is connected to the capacitance measurement unit 2. The capacitance measurement unit 2 is connected to the control unit 3. The control unit 3 outputs a control signal to an external device 50.

The coordinate inputting unit 1, as illustrated in FIG. 2, performs inputting operation by a close proximity operation in which an operating body 60 such as an operator's finger is placed in close proximity to or in contact with an input operating surface. Multiple capacitance detection units 1a, that is, M capacitance detection units and N capacitance detection units are arranged along the input operating surface of the coordinate inputting unit 1, in a matrix in the X-direction and the Y-direction that orthogonally intersects the X-direction, respectively (M and N are natural numbers).

The capacitance detection unit 1a has capacitance. When in order to perform the inputting operation, an operator places the operating body 60, such as the finger, in contact with the coordinate inputting unit 1, the capacitance of the capacitance detection unit 1a, which is present in an in-contact position and its neighborhood, increases.

The capacitance measurement unit 2 measures each capacitance of the multiple capacitance detection units 1a and performs analog-to-digital conversion (hereinafter referred to as AD conversion) in which the measured capacitance is converted from an analog signal to a digital signal. Furthermore, the capacitance measurement unit 2 outputs to the control unit 3 data on the capacitance, as a measurement signal, which is converted into the digital signal with the AD conversion.

The control unit 3 controls the capacitance measurement unit 2 and associates a value of the measurement signal for each of the multiple capacitance detection units 1a with coordinate information on the capacitance detection unit 1a and thus obtains the associated value of the measurement signal. Furthermore, the control unit 3 calculates the value of the measurement signal that is obtained from the capacitance measurement unit 2 by being associated with the coordinate information, and based on a result of the calculation, outputs the control signal to the external device 50. Furthermore, the control unit 3 has a timer function or a memory (not illustrated), and can perform a task, such as managing of a control interval using the timer function or storing of the result of calculating the obtained measurement signal or the value of the measurement signal.

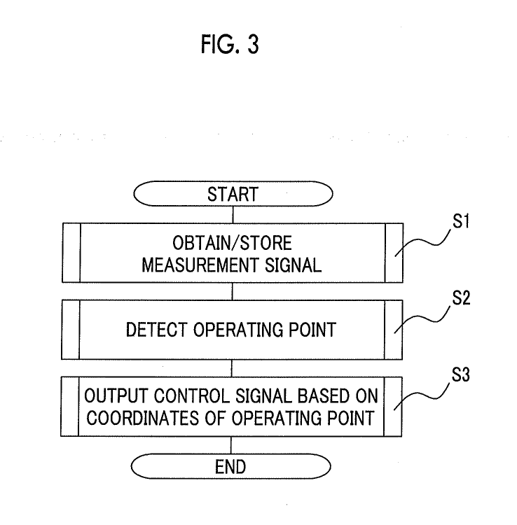

Next, operation of the inputting device 100 according to the first embodiment is described referring to FIG. 3. FIG. 3 is a flow chart illustrating an outline of the operation of the inputting device 100 according to the first embodiment. A processing step illustrated in the flow chart in FIG. 3 is periodically repeated using the timer function that is built into the control unit 3.

First, in Step S1, the control unit 3 controls the capacitance measurement unit 2 and thus obtains the measurement signal of each capacitance detection units 1a, makes the obtained measurement signal correspond to the coordinate information on the capacitance detection unit 1a, and stores the result of the matching in a measurement signal storage region of the memory included in the control unit 3 by setting the measurement signal storage region.

Next, in Step S2, detection of an operating point from the values of the measurement signals that are stored in the measurement signal storage region is performed, and the result of the detection and coordinate information on the detected operating point are stored in a detection information recording region and detection coordinate storage region of the memory included in the control unit 3, respectively, by setting the detection information recording region and the detection coordinate storage region.

In Step S3, the control signal is output that matches the coordinate information on the detected operating point that is stored in Step S2.

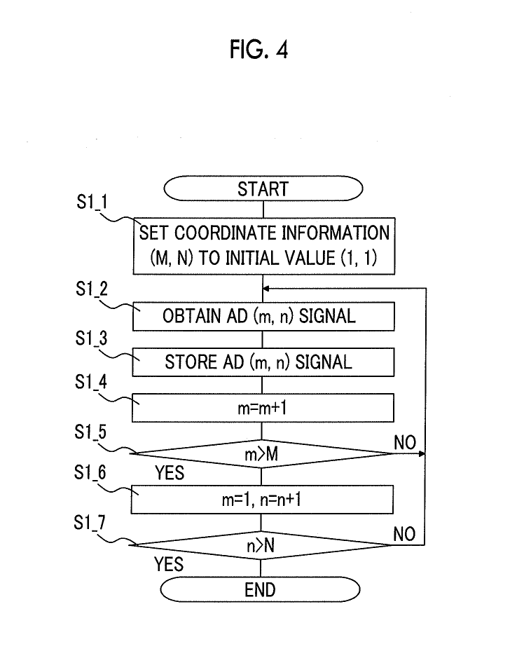

Next, processing tasks in Steps S1 to S3 illustrated in the flow chart in FIG. 3 are described in detail referring to FIGS. 4 to 6.

FIG. 4 is a flow chart illustrating detailed processing steps that result from subdivision of Step S1 in the flow chart illustrated in FIG. 3.

In Step S1_1 illustrated in the flow chart in FIG. 4, when a position at the m-th point in the X-direction and the n-th point in the Y-direction is set to be the coordinate information (m, n) with respect to the capacitance detection unit 1a that is a target for which the value of the measurement signal is obtained, the control unit 3 sets the coordinate information (m, n) to be initial values (for example, m=1, n=1). In Step S1_2, the control unit 3 obtains from the capacitance measurement unit 2 a value of a measurement signal AD (m, n) of the capacitance detection unit 1a, which corresponds to the coordinate information (m, n).

In Step S1_3, the value of the measurement signal AD (m, n) that is obtained in Step S1_2 is made to correspond to the coordinate information on the capacitance detection unit 1a, and thus the result of the matching is stored in the measurement signal storage region of the memory included in the control unit 3 by setting the measurement signal storage region.

In Step S1_4, a value m of the coordinate information (m, n) is increased by 1. In Step S1_5, the value m is compared with a maximum value M of the coordinate information in the X-direction. If the value m does not exceed the maximum value M, the processing returns to Step S12, and thus the value of the measurement signal AD (m+1, n) of the capacitance detection unit 1a that corresponds to the coordinate information (m+1, n) on the next coordinates that are updated is obtained. Subsequently, in the same manner as described above, Steps S1_2 to S1_5 are repeated until the value m is greater than the maximum value M.

If the value m is compared with the maximum value M and the value m exceeds the maximum value M in Step S1_5, then, the value m is returned to the initial value (for example, 1) and the value n is increased by 1 in Step S1_6, and the value n is compared with a maximum value N in Step S1_7. If the value n does not exceed the maximum value N, then, the processing returns to Step S1_2, and thus the value of the measurement signal AD (m, n+1) of the capacitance detection unit 1a that corresponds to the coordinate information (m, n+1) on the next coordinates that are updated is obtained. Subsequently, in the same manner as described above, Steps S1_2 to S1_7 are repeated until the value n is greater than the maximum value N.

If the value n is compared with the maximum value N and the value n exceeds the maximum value N in Step S1_7, then, operation in Step S1 in the flow chart in FIG. 3 is ended. With the processing described above, all the M×N capacitance detection units 1a, that is, the M capacitance detection units 1a and the N capacitance detection units which are arranged in a matrix in the X-direction and the Y-direction that orthogonally intersects the X-direction, respectively, are scanned, and the obtaining and the storing of the value of the measurement signal AD (m, n) of each of the capacitance detection units 1a are completed.

As described above, processing order is determined in a manner that sequentially proceeds from the first coordinates at the first point in the X-direction and at the first point in the Y-direction along the X-direction to the last coordinates (m=M, n=1) at the last point in the X-direction and then moves once in the Y-direction to the coordinates (m=1, n=2) and sequentially proceeds from there along the X-direction. A method of determining the processing order in this sequential manner is generally referred to as raster order or raster scan order.

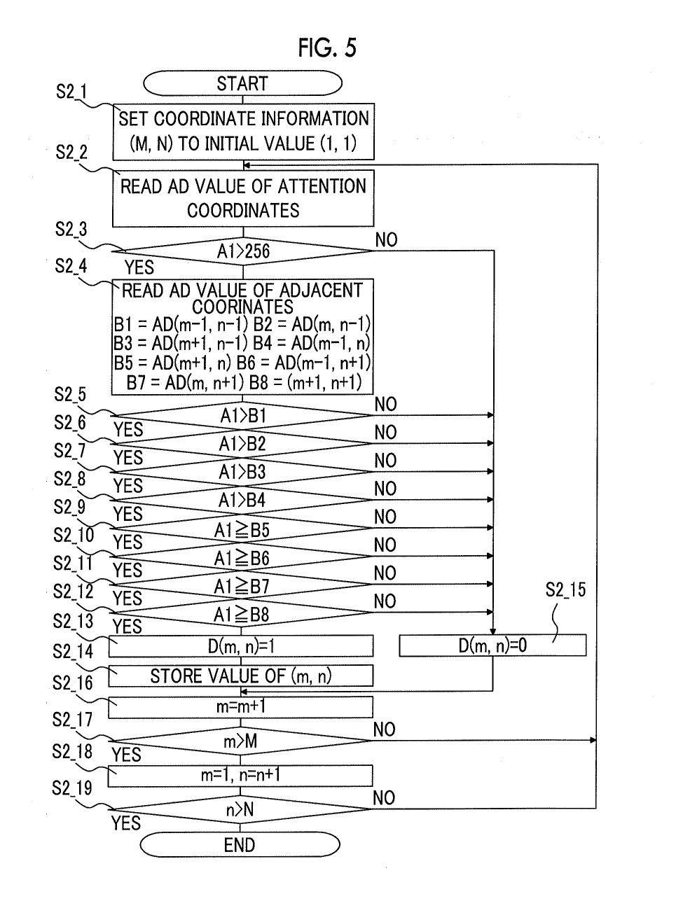

FIG. 5 is a flow chart illustrating detailed processing steps that result from subdivision of Step S2 in the flow chart illustrated in FIG. 3.

In Step S2_1 illustrated in the flow chart in FIG. 5, the control unit 3 sets the coordinate information on attention coordinates, to the initial values (m=1, and n=1), and in Step S2_2, obtains from the measurement signal storage region the value of the measurement signal AD (m, n) that corresponds to the attention coordinates. Moreover, the attention coordinates are determined, according to the raster order, from the coordinate information that corresponds to the capacitance detection unit 1a positioned at one end among the multiple capacitance detection units 1a that are arranged in a matrix, in the same order as used when the obtaining of the value of the measurement signal AD (m, n) described above is performed.

In Step S2_3, the value of the measurement signal AD (m, n) that corresponds to the attention coordinates that are obtained in Step S2_2 and a threshold (which is set to 256 according to the present embodiment) that is set in advance and stored in the control unit 3 are compared with each other. As a result of the comparison, if it is determined that the value of the measurement signal AD (m, n) that corresponds to the attention coordinates is greater than the threshold (256), the processing proceeds to Step S2_4. Furthermore, as a result of the comparison, if it is determined that the value of the measurement signal AD (m, n) that corresponds to the attention coordinates is equal to or less than the threshold, the processing proceeds to Step S2_15.

In Step S2_4, the value of the measurement signal that corresponds to each of the pieces of coordinate information on the 8 points adjacent to the attention coordinates is obtained from the measurement signal storage region. The values of the measurement signals that correspond to the pieces of coordinate information on the 8 points, respectively, are expressed as AD (m−1, n−1), AD (m, n−1), AD (m+1, n−1), AD (m−1, n), AD (m+1, n), AD (m−1, n+1), AD (m, n+1), and AD (m+1, n+1), respectively.

If the value m is 1 and the value n is 1, and if the value m is the maximum M and the value n is the maximum N, the capacitance detection unit 1a is not present at the points that have the coordinate information that falls outside of the coordinate inputting unit 1, among the multiple pieces of coordinate information that are adjacent to the attention coordinates. For this reason, if the value m is 1, the values of the measurement signals that correspond to (m−1, n−1), (m−1, n), and (m−1, n+1), respectively, are not present, among the values of the measurement signals that correspond to the adjacent 8 pieces of coordinate information, respectively. Furthermore, if the value n is 1, the values of the measurement signals that correspond to (m−1, n−1), (m, n−1), and (m+1, n−1), respectively, are not present among the values of the measurement signals that correspond to the adjacent 8 pieces of coordinate information, respectively. In the same manner, if the value m is the maximum value M, the values of the measurement signals that correspond to (m+1, n−1), (m+1, n), and (m+1, n+1), respectively, are not present, and if the value n is the maximum value N, the values of the measurement signals that correspond to (m−1, n+1), (m, n+1), and (m+1, n+1), respectively, are not present. If the capacitance detection unit 1a is not present at the points that have their respective multiple pieces of coordinate information that are adjacent to the attention coordinates (m, n), the value of the measurement signal that corresponds to that coordinate information is set to a predetermined fixed value (“0” according to the present embodiment) and the processing proceeds to Step S2_5.

In Steps S2_5 to S2_12, the control unit 3 compares the value of the measurement signal AD (m, n) of the attention coordinates and the value of the measurement signal of each of the pieces of coordinate information on the 8 points that are adjacent to the attention coordinates. If compared with the values of the measurement signals of the pieces of coordinate information that are adjacent to the attention coordinates, while the attention coordinates that are determined according to the raster order make a round, the value of the measurement signal AD (m, n) of the attention coordinates is compared with the value of the measurement signal of the coordinate information at the position that is already processed as the attention coordinates and with the value of the measurement signal of the coordinate information at the position that is not processed as the attention coordinates, which are different as follows. When the value of the measurement signal AD (m, n) of the attention coordinates and the value of the measurement signal of the coordinate information at the position that is already processed as the attention coordinates are compared with each other, if the value of the measurement signal AD (m, n) of the attention coordinates is greater than the value of the measurement signal of the adjacent coordinate information, the comparison with the value of the measurement signal of the next adjacent coordinates is performed. Steps S2_5 to S2_8 correspond to this. Furthermore, when the value of the measurement signal AD (m, n) of the attention coordinates and the value of the measurement signal of the coordinate information at the position that is not processed as the attention coordinates are compared with each other, if the value of the measurement signal AD (m, n) is equal to or greater than the values of the measurement signals of multiple adjacent pieces of coordinate information, the comparison with the value of the measurement signal of the next adjacent coordinates is performed. Steps S2_9 to S2_12 correspond to this.

As a result of the comparison, if the value of the measurement signal AD (m, n) of the attention coordinates is equal to or greater or greater than the values of the measurement signals of the pieces of coordinate information on the 8 points that are adjacent to the attention coordinates, the processing proceeds to Step S2_13. Furthermore, if it is determined that the value of the measurement signal AD (m, n) of the attention coordinates is equal to or smaller, or smaller than the value of the measurement signal that corresponds to any one of the pieces of coordinate information on the 8 points that are adjacent to the attention coordinates, the processing proceeds to Step S2_15.

In Step S2_13, as a result of the comparison performed in Steps S2_5 to S2_12, the value of the measurement signal AD (m, n) of the attention coordinates is equal to or greater, or greater than the values of the measurement signals of the pieces of coordinate information on the 8 points that are adjacent to the attention coordinates. The detection information (for example, 1) as the result of the detection is stored in a recording region D (m, n) for the detection information that corresponds to the coordinate information, with the coordinate information on these attention coordinates as the operating point at which the operating body 60 performs the close proximity operation, and the processing proceeds to Step S2_14.

In Step S2_14, the control unit 3 stores the coordinate information on the attention coordinates in the detection coordinate storage region, and the processing proceeds to Step S2_16.

The value of the measurement signal AD (m, n) of the attention coordinates in Step S2_3 is equal to or less than the threshold in Step S2_15, but as the result of the comparison performed in Steps S2_5 to S2_12, the value of the measurement signal AD (m, n) of the attention coordinates is equal to or smaller, or smaller than the values of the measurement signals of the pieces of coordinate information on the 8 points that are adjacent to the attention coordinates. Therefore, because it is not determined that these attention coordinates are the operating point at which the operating body 60 performs the close proximity operation, non-detection information (for example, 0) is stored, as a result of non-detection, in the recording region D (m, n) for the detection information that corresponds to the coordinate information, and the processing proceeds to Step S2_16.

In Step S2_16, the value m of the coordinate information (m, n) is increased by 1. In Step S2_17, the value m is compared with the maximum value M of the coordinate information in the X-direction. If the value m does not exceed the maximum value M, the processing returns to Step S2_2, and the value of the measurement signal that corresponds to the coordinate information (m+1, n) on the next coordinates that are updated is obtained from the measurement signal storage region. Subsequently, in the same manner as described above, Steps 2_2 to S2_16 are repeated until the value m is greater than the maximum M.

If the value m is compared with the maximum value M and the value m exceeds the maximum value M in Step S2_17, then, the value m is returned to the initial value (for example, 1) and the value n is increased by 1 in Step S2_18, and the value n is compared with the maximum value N in Step S2_19. If the value n does not exceed the maximum value N, the processing returns to Step S2_2, and the value of the measurement signal AD that corresponds to the coordinate information (m, n+1) on the next coordinates that are updated is obtained from the measurement signal storage region. Subsequently, in the same manner as described above, Steps S2_2 to S2_17 are repeated until the value n is greater than the maximum value N.

If the value n is compared with the maximum value N and the value n exceeds the maximum value N in Step S2_19, then, operation in Step S2 in the flow chart in FIG. 3 is ended. With the processing described above, the detecting of positions of the close proximity operations that correspond to all the M×N capacitance detection units 1a, that is, the M capacitance detection units 1a and the N capacitance detection units, which are arranged in a matrix in the X-direction and the Y-direction that orthogonally intersects the X-direction respectively, and the storing of the results of the detecting of the positions are completed.

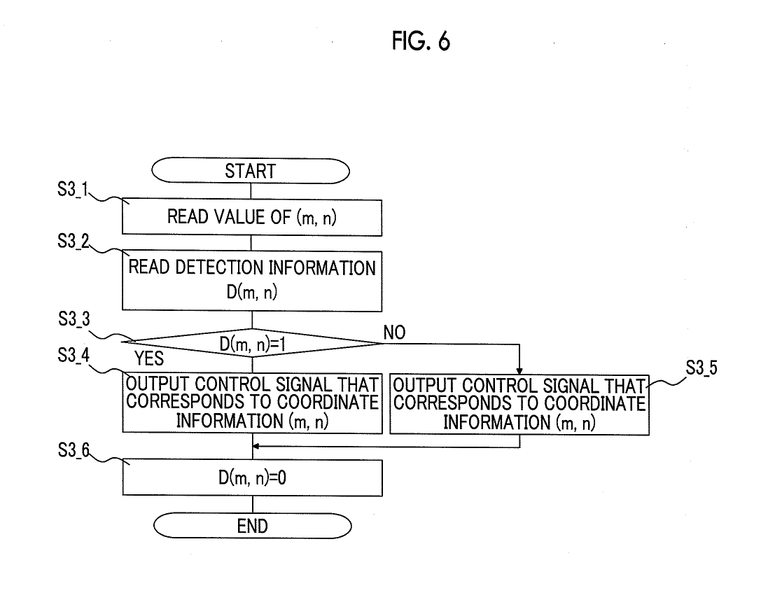

FIG. 6 is a flow chart illustrating detailed processing steps that result from subdivision of Step S3 in the flow chart illustrated in FIG. 3.

In Step S3_1 illustrated in the flow chart in FIG. 6, the control unit 3 obtains the coordinate information (m, n) indicating the detecting of the position of the close proximity operation, which is stored in Step S2_14, from the detection coordinate storage region and the processing proceeds to Step S3_2.

In Step S3_2, the value of the detection information that is stored in Step S2_13 is obtained from the recording region D (m, n) for the detection information using the coordinate information that is obtained in Step S3_1, and the processing proceeds to Step S3_3.

In Step S3_3, the value of the detection information that is obtained in Step S3_2 is checked, and because if the value is “1,” the close proximity operation is performed, the processing proceeds to Step S3_4, and if the value is “0,” the processing proceeds to S3_5.

In Step S3_4, because it is determined that the contact by the operation is performed in Step S3_3, the control signal that corresponds to the coordinate information (m, n) indicating the detecting of the position of the close proximity operation, which is stored in the detection coordinate storage region, is output, and the processing proceeds to Step S3_6.

In Step S3_5, because it is determined that the contact by the operation is not present in Step S3_3, the control signal that corresponds to the non-inputting is output, and the processing proceeds to Step S3_6.

In Step S3_6, the value of the detection information is eliminated (is reset to 0), and thus the operation in Step S3 in the flow chart in FIG. 3 is ended.

Next, processing in Step S2 illustrated in FIG. 3 is described in detail referring to FIGS. 5 to 7C.

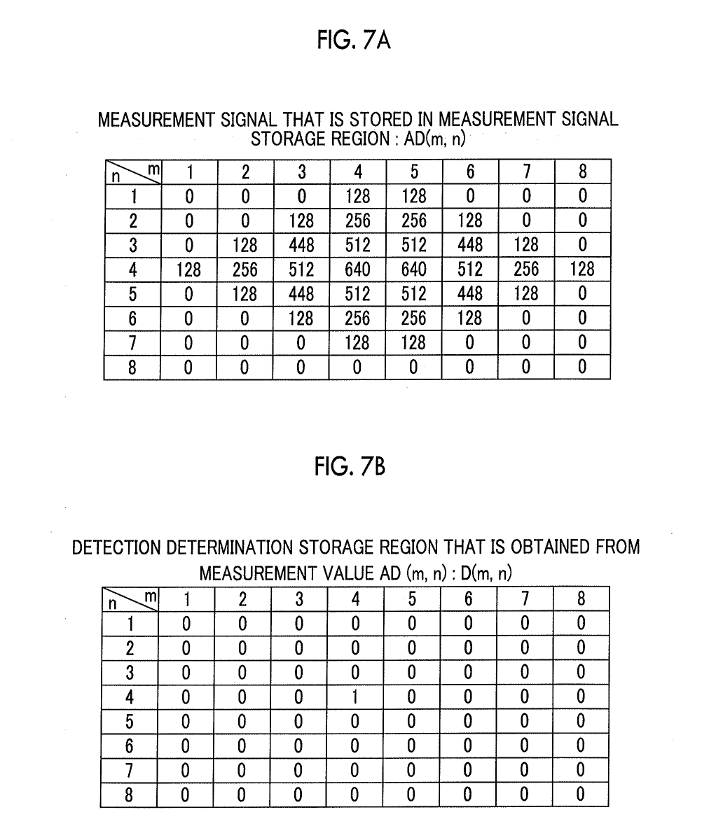

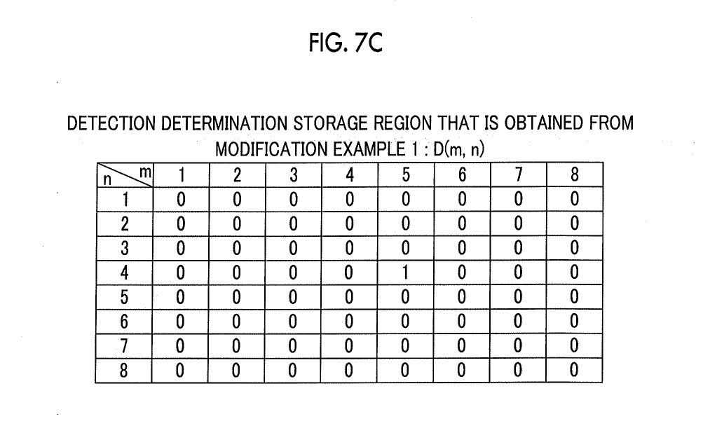

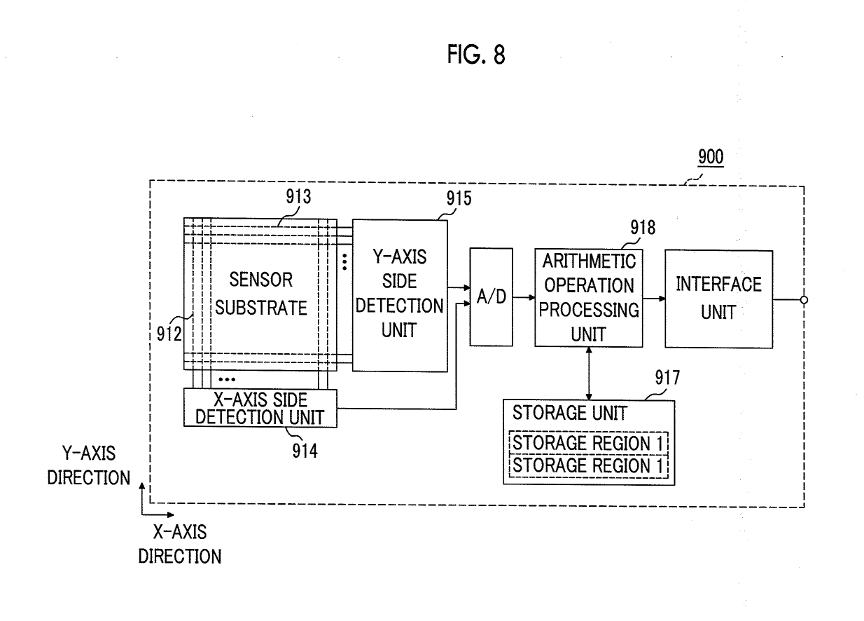

FIGS. 7A to 7C are diagrams for describing the measurement signal storage region in which the value of the measurement signal AD (m, n) that is obtained by the operation in the flow charts illustrated in FIGS. 4 and 5, is stored, and the value of the recording region D (m, n) for the detection information, which is obtained from the obtained value of the measurement signal AD (m, n). FIG. 7A illustrates an example of the value of the measurement signal AD (m, n) of each capacitance detection unit 1a, which is obtained in Step S1 in the flow chart illustrated in FIG. 4. For a simple description, m and n are values from 1 to 8, respectively, and the measurement signal AD is configured from 64 items of data in all. FIG. 7B illustrates the value of the recording region D (m, n) for the detection information, which is obtained from the value of the measurement signal AD (m, n) of each capacitance detection unit 1a, which is illustrated in FIG. 7A, when performing the steps in the flow chart illustrated in FIG. 5.

FIG. 7A illustrated an example in which because the operations are performed at positions that are equivalent to m=4 and n=4, and m=5 and n=4 that are adjacent pieces of coordinate information, the value of the measurement signal AD (m, n) of the coordinates that are equivalent to the corresponding positions and the value of the measurement signal (m, n) of its adjacent coordinates are greater than the rest.

A specific example of processing in the steps in the flow chart illustrated in FIG. 5 is described using the value of the measurement signal AD (m, n) of each capacitance detection unit 1a, which is illustrated in FIG. 7A.

In Step S2_1, the coordinate information on attention coordinates is set to the initial value (m=1, and n=1), and in Step S2_2, if the value of the measurement signal AD (m, n) that corresponds to the attention coordinates is obtained from the measurement signal storage region, the value of the measurement signal AD (1, 1) of the attention coordinates is “0.” For this reason, the processing proceeds from Step S2_3 to Step S2_15, and “0” is written for the value of the storage region D (1, 1) for the detection information.

Next, in Step S2_16, 1 is added to the value m of the coordinate information on the attention coordinates (thereby resulting in m=2 and n=1), and the processing that returns to Step S2_2 is repeated. If the pieces of coordinate information on the attention coordinates are (m=4, n=1) and (m=5, n=1), the values of the measurement signals AD (4, 1) and AD (5, 1) that are obtained in Step S2_2 are 128, but because the threshold with which the values of the measurement signals AD (4, 1) and AD (5, 1) have to be compared in Step S2_3 is 256, the processing proceeds to Step S2_15.

When the processing progresses until the coordinate information on the attention coordinates is (m=8, n=1) and the processing proceeds to Step S2_16, because the value m is 9, the processing proceeds from Step S2_17 to Step S2_18, the coordinate information on the attention coordinates is set to (m=1, n=2), and the processing that returns from Step S2_19 to Step S2_2 is repeated.

When the operation described above is repeated and the processing proceeds until the coordinate information on the attention coordinates is (m=3, n=3), because the value of the measurement signal AD (3, 3) that is obtained in Step S2_2 is 488 and exceeds the threshold of 256 with which the value of the measurement signal AD (3, 3) has to be compared in Step S2_3, the processing proceeds to Step S2_4.

In Step S2_4, the value of the measurement signal that corresponds to each of the pieces of coordinate information on the 8 points adjacent to the attention coordinates is obtained from the measurement signal storage region. The values of the measurement signals that correspond to the pieces of coordinate information on the 8 points, respectively, are AD (2, 2), AD (3, 2), AD (4, 2), AD (2, 3), AD (4, 3), AD (2, 4), AD (3, 4), and AD (4, 4), respectively. These values are temporarily retained in registers and the like that are indicated with B1 to B8, respectively, as illustrated in Step S2_4. Among the pieces of coordinate information on the coordinates, the pieces of coordinate information on the coordinates which are (2, 2), (3, 2), (4, 2), and (2, 3), are the pieces of coordinate information that are already processed as the attention coordinates that are determined in the raster order. Furthermore, the pieces of coordinate information on the coordinates that are (4, 3), (2, 4), (3, 4), and (4, 4) are the pieces of coordinate information that are not yet processed as the attention coordinates.

In the pieces of coordinate information that are already processed as the attention coordinates, AD (2, 2)=B1, AD (3, 2)=B2, AD (4, 2)=B3, and AD (2, 3)=B4, which are the values of the measurement signals, are B1=0, B2=128, B3=256, and B4=128 that are seen from FIG. 7A, respectively. In the same manner, further, in the processing in which the pieces of coordinate information are not processed as the attention coordinates, AD (4, 3)=B5, AD (2, 4)=B6, AD (3, 4)=B7, and AD (4, 4)=B8 that are the values of the measurement signals are B5=512, B6=256, B7=512, and B8=640 that are seen from FIG. 7A, respectively.

In Steps S2_5 to S2_8, because the value of the measurement signal AD (3, 3) on the attention coordinates is greater, the processing proceeds to Step S2_9. However, in Step S2_9, because the value of the measurement signal AD (4, 3) on the adjacent coordinates (4, 3) is greater than the value of the measurement signal on the attention coordinates, the processing proceeds to Step S2_15. Thereafter, as described above, the processing goes through Step S2_16 and S2_17, and the processing that returns to Step S2_2 is repeated.

In the same manner, if the coordinate information on the attention coordinates is (m=4, n=3), the processing proceeds from Step S2_11 to Step S2_15, and goes through Steps S2_16 and S2_17, and the processing that returns to Step S22 is repeated.

When the coordinate information on the attention coordinates progress until (m=4, n=4), the value of the measurement signal AD (4, 4), which is obtained in Step S2_2, is 640 and the processing proceeds from Step S2_3 to Step S2_4. The values of the measurement signals that correspond to the pieces of coordinate information on the 8 points, respectively, that are adjacent to the attention coordinates, which are obtained in Step S2_4, are B1=448, B2=512, B3=512, B4=512, B5=640, B6=448, B7=512, and B8=512.

In Steps S2_5 to S2_8, because the value of the measurement signal AD (4, 4) of the attention coordinates is greater, the processing progresses until Step S2_9. In Steps S2_9 to S2_12, because the value of the measurement signal AD (4, 4) of the attention coordinates is equal to or greater than the value of the measurement signal of the adjacent coordinates, the processing proceeds to Step S2_13.

In Step S2_13, the control unit 3 stores the detection information “1” as the result of the detection in the recording region D (4, 4) for the detection information that corresponds to the coordinate information, with the coordinate information (m=4, n=4) on the attention coordinates as the operating point at which the operating body 60 performs the close proximity operation, and causes the processing to proceed to Step S2_14.

In Step S2_14, the control unit 3 stores the coordinate information (m=4, n=4) on the attention coordinates in the detection coordinate storage region and causes the processing to go through Step S2_16 and S2_17 and return to Step S2_2.

If the coordinate information on the attention coordinates is (m=5, n=4), the value of the measurement signal AD (5, 4) of the attention coordinates, which is obtained in Step S2_2, is 640, and the processing proceeds from Step S2_3 to Step S2_4. The values of the measurement signals that correspond to the pieces of coordinate information on the 8 points, respectively, that are adjacent to the attention coordinates, which are obtained in Step S2_4, are B1=512, B2=512, B3=448, B4=640, B5=512, B6=512, B7=512, and B8=448.

In Steps S2_5 to S2_7, because the value of the measurement signal AD (5, 4) on the attention coordinates is greater, the processing proceeds to Step S2_8. However, in Step S2_8, because the value of the measurement signal AD (5, 4) of the attention coordinates and the value of the measurement signal AD (4, 4) of the adjacent coordinates (4, 4) are the same in magnitude, the processing proceeds to Step S2_15. Thereafter, as described above, the processing goes through Step S2_16 and S2_17, and the processing that returns to Step S2_2 is repeated.

Hereafter, in the same manner, when the processing is performed until the coordinate information on the attention coordinates is (m=8, n=8), the result that is illustrated in FIG. 7B can be obtained in the recording region D (m, n) for the detection information. Furthermore, the coordinate information on the attention coordinates (m=4, n=4), in which the detection information “1” is stored, is stored in the detection coordinate storage region.

As described above, with the processing in Step S2 in the flow chart illustrated in FIG. 3, the result of the detection of the close proximity is stored in the recording region D (m, n) for the detection information, and the detected coordinate information is stored in the detection coordinate storage region. In Step S3, the control signal corresponding to an operating position can be output using this information.

Effects according to the present embodiment are described below.

In the inputting device 100 according to the present embodiment, the control unit 3 is configured in such a manner that the attention coordinates are determined in order according to the coordinate information on the capacitance detection units 1a, the value of the measurement signal AD (m, n) of the determined attention coordinates and each of the values of the measurement signals of the multiple pieces of coordinate information that are adjacent to the attention coordinates are compared with each other, and if the value of the measurement signal AD (m, n) of the attention coordinates is equal to or greater, or greater than the values of the measurement signals of the multiple pieces of coordinate information that are adjacent to the attention coordinates, the attention coordinates are detected as the operating point at which the operating body 60 performs the close proximity operation.

Accordingly, the operating point at which the operating body 60 performs the close proximity operation can be detected by repeatedly comparing the value of the measurement signal AD (m, n) of the attention coordinates and the values of the measurement signals of the multiple pieces of coordinate information that are adjacent to the attention coordinates. For this reason, because the number of times that an arithmetic operation is performed can be decreased without performing the complex arithmetic operation, the inputting operation can be rapidly processed. Accordingly, the inputting device in which the number of times that the arithmetic operation is performed is small, and which quickly responds to the inputting operation can be provided.

Furthermore, in the inputting device 100 according to the present embodiment, the control unit 3 stores the threshold, and if the value of the measurement signal AD (m, n) of the attention coordinates is greater than the threshold, compares the value of the measurement signal AD (m, n) of the attention coordinates and each of the values of the measurement signals of the multiple pieces of coordinate information that are adjacent to the attention coordinates.

Accordingly, if the value of the measurement signal AD (m, n) of the attention coordinates is equal to or less than the threshold, because the comparison with the values of the measurement signals of the adjacent multiple pieces of coordinate information is not performed, the number of times that the comparison is performed can be reduced. For this reason, the number of times that the control unit 3 performs the arithmetic operation ends up being small, and processing speed can be improved.

Furthermore, the inputting device 100 according to the present embodiment is configured in such a manner that the number of the multiple pieces of coordinate information that are adjacent to the attention coordinates is 8.

Accordingly, in the capacitance detection units 1a that are arranged in a matrix, because the operating point is detected as the result of performing the comparison with the values of the measurement signals of all the pieces of coordinate information that are adjacent to the attention coordinates, the operating point at which the operating body 60 performs the close proximity operation can be correctly detected.

Furthermore, in the inputting device 100 according to the present embodiment, if the capacitance detection unit 1a is not present at the points that have their respective multiple pieces of coordinate information that are adjacent to the attention coordinates, the value of the measurement signal that corresponds to the corresponding coordinate information is set to be the predetermined fixed value.

Accordingly, if the capacitance detection unit 1a is not present at the points that have their respective multiple pieces of coordinate information that are adjacent to the attention coordinates, because the predetermined fixed value is used as the value of the measurement signal, the close proximity operation performed by the operating body 60 can be detected also at the capacitance detection unit 1a that is arranged in the end portion, among the capacitance detection units 1a that are arranged in a matrix.

Furthermore, in the inputting device 100 according to the present embodiment, the attention coordinates are determined according to the raster order, from the coordinate information that corresponds to the capacitance detection unit 1a positioned at one end among the multiple capacitance detection units 1a that are arranged in a matrix.

Accordingly, because the attention coordinates are determined according to the raster order, from the coordinate information that corresponds to the capacitance detection unit 1a positioned at one end among the multiple capacitance detection units 1a that are arranged in a matrix, when determining the attention coordinates, the coordinate information can be simply updated by increasing the coordinate information in a sequential order. For this reason, because the determination of the attention coordinates can be quickly performed, the inputting device that responds faster to the inputting operation can be provided.

Furthermore, in the inputting device 100 according to the present embodiment, the value of the measurement signal AD (m, n) of the attention coordinates is compared with the values of the measurement signals of the multiple pieces of coordinate information that are adjacent to the attention coordinates, for detecting the operating point during a period of time when the attention coordinates that are determined according to the raster order make a round. The attention coordinates are detected as the operating point at which the operating body 60 performs the close proximity operation, if the value of the measurement signal AD (m, n) of the attention coordinates is greater than the values of the measurement signals of the adjacent multiple pieces of coordinate information, when compared with the values of the measurement signals of the multiple pieces of coordinate information that are adjacent to the position that is already processed as the attention coordinates. The attention coordinates are detected as the operating point at which the operating body 60 performs the close proximity operation, if the value of the measurement signal AD (m, n) of the attention coordinates is equal to or greater than the values of the measurement signals of the adjacent multiple pieces of coordinate information, when compared with the values of the measurement signals of the multiple pieces of coordinate information that are adjacent to the position that is not processed as the attention coordinates.

Accordingly, even though multiple coordinates, each of which has the measurement signal of the same value; are successively present, the coordinates to detect are determined as one operating point at which the operating body 60 performs the close proximity operation, by repeatedly comparing the value of the measurement signal AD (m, n) of the attention coordinates and the values of the measurement signals of the multiple pieces of coordinate information adjacent to the attention coordinates. Therefore, because the number of times that the arithmetic operation is performed ends up being small and the processing speed is improved, the inputting device that responds faster to the inputting operation can be provided.

As described above, as the inputting device 100 according to the present embodiment, the inputting device in which the number of times that the arithmetic operation is performed is small, and which quickly responds to the inputting operation can be provided.

The inputting device 100 according to the embodiment of the present invention is described in detail above, but the present invention is not limited to the embodiment described above and various modifications to the embodiment can be made within the scope that does not deviate from the gist of the invention. For example, modifications to the embodiment can be made as follows, and these modifications also fall within the technological scope of the present invention.

(1) According to the present embodiment, the example is described in which the value of the measurement signal AD (m, n) of the attention coordinates are compared with the values of the measurement signals of the multiple pieces of coordinate information that are adjacent to the attention coordinates, for detecting the operating point during a period of time when the attention coordinates that are determined according to the raster order make a round. In the example, attention coordinates are detected as the operating point at which the operating body 60 performs the close proximity operation, if the value of the measurement signal AD (m, n) of the attention coordinates is greater than the values of the measurement signals of the adjacent multiple pieces of coordinate information when compared with the values of the measurement signals of the multiple pieces of coordinate information that are adjacent to the position that is already processed as the attention coordinates. In the example, the attention coordinates are detected as the operating point at which the operating body 60 performs the close proximity operation, if the value of the measurement signal AD (m, n) of the attention coordinates is equal to or greater than the values of the measurement signals of the adjacent multiple pieces of coordinate information when compared with the values of the measurement signals of the multiple pieces of coordinate information that are adjacent to the position that is not processed as the attention coordinates. However, a modification may be made in which the value of the measurement signal at the position that is already processed as the attention coordinates and the value of the measurement signal at the position that is not processed as the attention coordinates are exchanged. That is, the attention coordinates may be detected as the operating point at which the operating body 60 performs the close proximity operation, if the value of the measurement signal AD (m, n) of the attention coordinates is equal to or greater than the values of the measurement signals of the adjacent multiple pieces of coordinate information, when compared with the values of the measurement signals of the multiple pieces of coordinate information that are adjacent to the position that is already processed as the attention coordinates. The attention coordinates may be detected as the operating point at which the operating body 60 performs the close proximity operation, if the value of the measurement signal AD (m, n) of the attention coordinates is greater than the values of the measurement signals of the adjacent multiple pieces of coordinate information when compared with the values of the measurement signals of the multiple pieces of coordinate information that are adjacent to the position that is not processed as the attention coordinates. In this case, the value of the recording region D (m, n) for the detection information, which is obtained using the value of the measurement signal AD (m, n) of each of the capacitance detection units 1a illustrated in FIG. 7A is as illustrated in FIG. 7C, the coordinates to detect are shifted by one, but the detection can be performed in the same manner.
(2) According to the present embodiment, the example is described in which the inputting operation is performed at one point on the coordinate inputting unit 1, but the detection can be easily performed at two or more points by providing a configuration in such a manner that the multiple pieces of coordinate information are stored in the detection coordinate storage region. The inputting device can be provided in which various inputting operations can be supported by performing the detection at the multiple points.
(3) According to the present embodiment, the example is described in which the processing is performed by directly inputting the value of the measurement signal AD (m, n), but a modification may be made in which the detection is performed after performing the processing that removes a change in the value of the measurement signal due to a temperature change, or effects such as noise.
(4) According to the present embodiment, the example is described in which the control signal that corresponds to the coordinate information of the detected attention coordinates is output, but a configuration may be provided in such a manner that a more accurate detection position is estimated from the value of the measurement signal of the detected coordinate information and from the value of the measurement signal of the adjacent coordinates.

It should be understood by those skilled in the art that various modifications, combinations, sub-combinations and alterations may occur depending on design requirements and other factors insofar as they are within the scope of the appended claims of the equivalents thereof.

What is claimed is:

1. An inputting device comprising:
a coordinate inputting unit in which multiple capacitance detection units are arranged in a matrix, and at which an operating body performs a close proximity operation;
a capacitance measurement unit that measures an electrostatic capacitance of each of the multiple capacitance detection units and outputs the measured electrostatic capacitance as a measurement signal; and
a control unit that controls the capacitance measurement unit, associates the measurement signal with coordinate information on the capacitance detection unit, obtains and calculates the associated measurement signal, calculates, and based on a result of the calculation, outputs a control signal,
wherein the control unit determines attention coordinates in an order according to the coordinate information on the capacitance detection units, compares a value of the measurement signal of the determined attention coordinates and each of the values of the measurement signals of the multiple pieces of coordinate information that are adjacent to the attention coordinates, and if the value of the measurement signal of the attention coordinates is equal to or greater than the values of the measurement signals of the multiple pieces of coordinate information that are adjacent to the attention coordinates, detects the attention coordinates as an operating point at which an operating body performs a close proximity operation.

2. The inputting device according to claim 1,
wherein the control unit stores a threshold, and if the value of the measurement signal of the attention coordinates is greater than the threshold, compares the value of the measurement signal of the attention coordinates and each of the values of the measurement signals of the multiple pieces of coordinate information that are adjacent to the attention coordinates.

3. The inputting device according to claim 1,
wherein the multiple pieces of coordinate information that are adjacent to the attention coordinates are present at 8 points.

4. The inputting device according to claim 1,
wherein if the capacitance detection unit is not present at the points that have their respective multiple pieces of coordinate information that are adjacent to the attention coordinates, the value of the measurement signal that corresponds to the corresponding coordinate information is set to a predetermined fixed value.

5. The inputting device according to claim 1,
wherein the attention coordinates are determined according to raster order, from the coordinate information that corresponds to the capacitance detection unit positioned at one end among the multiple capacitance detection units that are arranged in a matrix.

6. The inputting device according to claim 5,
wherein the value of the measurement signal of the attention coordinates is compared with the values of the measurement signals of the multiple pieces of coordinate information that are adjacent to the attention coordinates, for detecting the operating point during a period of time when the attention coordinates that are determined according to the raster order make a round,
wherein the attention coordinates are detected as the operating point at which the operating body performs the close proximity operation, if the value of the measurement signal of the attention coordinates is greater than the values of the measurement signals of the adjacent multiple pieces of coordinate information, when compared with the values of the measurement signals of the multiple pieces of coordinate information that are adjacent to the position that is already processed as the attention coordinates, and
wherein the attention coordinates are detected as the operating point at which the operating body performs the close proximity operation, if the value of the measurement signal of the attention coordinates is equal to or greater than the values of the measurement signals of the adjacent multiple pieces of coordinate information, when compared with the values of the measurement signals of the multiple pieces of coordinate information that are adjacent to the position that is not processed as the attention coordinates.

7. The inputting device according to claim 5,
wherein the value of the measurement signal of the attention coordinates is compared with the values of the measurement signals of the multiple pieces of coordinate information that are adjacent to the attention coordinates, for detecting the operating point during a period of time when the attention coordinates that are determined according to the raster order make a round,
wherein the attention coordinates are detected as the operating point at which the operating body performs the close proximity operation, if the value of the measurement signal of the attention coordinates is equal to or more than the values of the measurement signals of the adjacent multiple pieces of coordinate information, when compared with the values of the measurement signals of the multiple pieces of coordinate information that are adjacent to the position that is already processed as the attention coordinates, and
wherein the attention coordinates are detected as the operating point at which the operating body performs the close proximity operation, if the value of the measurement signal of the attention coordinates is greater than the values of the measurement signals of the adjacent multiple pieces of coordinate information, when compared with the values of the measurement signals of the multiple pieces of coordinate information that are adjacent to the position that is not processed as the attention coordinates.
